(19) United States
(12) Patent Application Publication
(10) Pub. No.: US 2007/0000043 A1
(43) Pub. Date: Jan. 4, 2007

(54) WARM BATH EQUIPMENT

(75) Inventor: Fukuzo Nakayama, Osaka (JP)

Correspondence Address: VEDDER PRICE KAUFMAN & KAMMHOLZ, 222 N. LASALLE STREET, CHICAGO, IL, 60601, US

(73) Assignee: DAILEO CO., LTD., Osaka (JP)

(21) Appl. No.: 11/422,389

(22) Filed: Jun. 6, 2006

(30) Foreign Application Priority Data
Jun. 30, 2005 (JP) 2005-191529

(51) Int. Cl. A61H 33/06

(52) U.S. Cl. 4/529

(57) ABSTRACT

In order to provide a warm bath equipment that can effectively promote sufficient perspiration to contribute to beauty and health enhancement, the warm bath equipment includes a bed body made of a stone plate for generating far infrared rays and a dome mounted on the bed body so as to be openable and closable, and a nozzle of a steam generator is provided at one side in the longitudinal direction on the upper surface of the bed body.

### BACKGROUND OF THE INVENTION

1. Field of the Invention

The present invention relates to a warm bath equipment that promotes perspiration to contribute to beauty and health enhancement.

2. Description of the Prior Art

As this type of warm bath equipment, there is one including a bed with an electric heating equipment and a dome for covering an upper part of the bed, in which perspiration of a bather lying on the bed in this dome is promoted by heat from the electric heating equipment (see Patent Document 1).

Patent Document 1: Japanese Published Unexamined Patent Application No. 2003-245326

However, it can hardly be said that conventional warm bath equipments provide sufficient perspiration.

### SUMMARY OF THE INVENTION

Therefore, it is an object of the present invention to provide a warm bath equipment that can effectively promote sufficient perspiration on a bather to contribute to health enhancement.

In order to achieve the above-mentioned object, a warm bath equipment according to the present invention includes a bed body made of a stone plate for generating far infrared rays and a dome mounted on the bed body so as to be detachable, wherein a nozzle connected to a steam generator is arranged at one side in the longitudinal direction on the upper surface of the bed body.

When using warm bath equipment, the dome is mounted on the bed body, and a bather lies on the bed body in the dome. Then, far infrared rays generated by the bed body are irradiated onto the bather, and simultaneously therewith, steam is sprouted from the nozzle of the steam generator into the dome. Thereby, perspiration of the bather is sufficiently promoted so that a beauty and health enhancement effect can be obtained.

In a preferred embodiment of the present invention, a heater for heating the bed body is provided. According to this structure, far infrared rays can be generated by the bed body with a simple structure.

In a preferred embodiment of the present invention, herb steam is spouted from the nozzle of the steam generator. According to this structure, a healing effect can be obtained by the herb steam, and a relaxing feeling and comfortable perspiration owing to the herb steam can be further promoted.

### BRIEF DESCRIPTION OF THE DRAWINGS

FIG. 1 is a side view showing an embodiment of a warm bath equipment according to the present invention;

FIG. 2 is a plan view of the same;

FIG. 3 is a rear view of the same; and

FIG. 4 is an enlarged sectional view from a line X-X direction of FIG. 2.

### DESCRIPTION OF THE PREFERRED EMBODIMENTS

Hereinafter, a warm bath equipment according to the present invention will be described in detail with reference to the drawings.

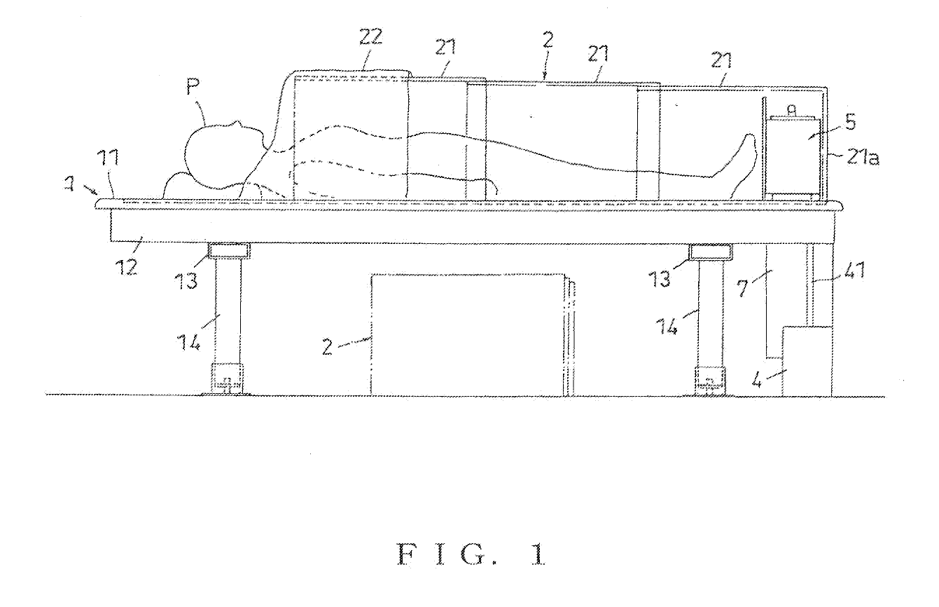

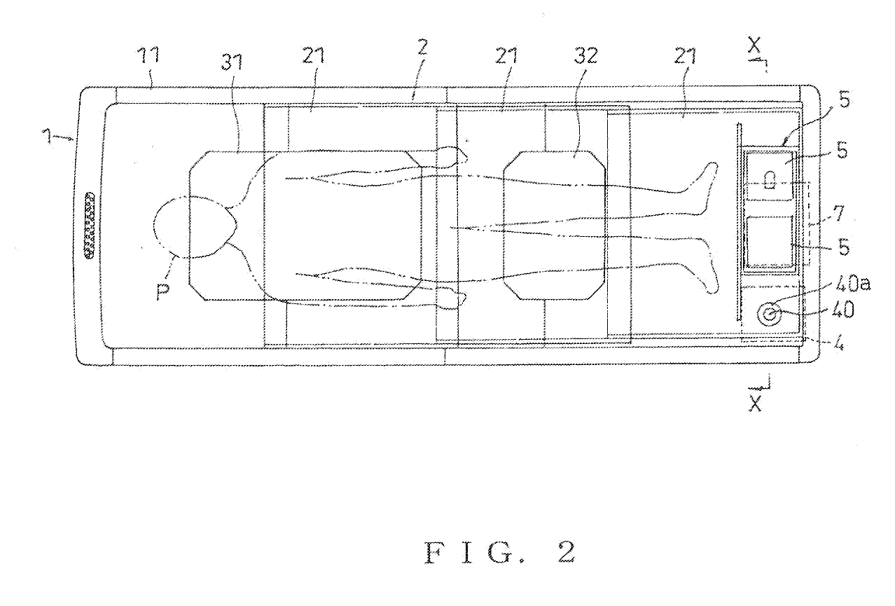

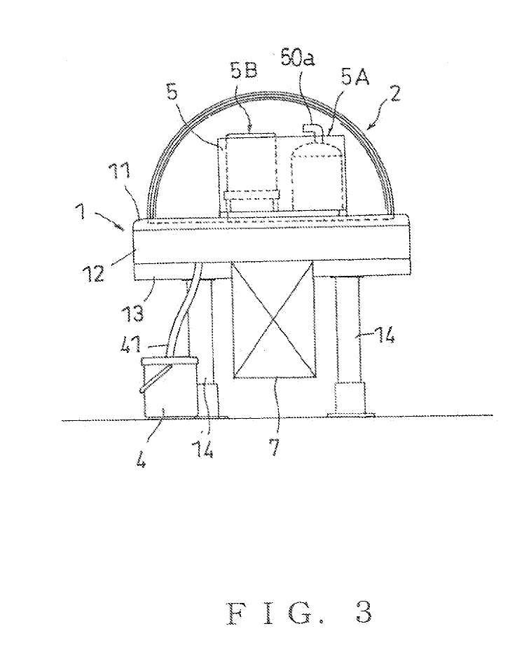

FIG. 1 is a side view showing an embodiment of a warm bath equipment according to the present invention, FIG. 2 is a plan view of the same, and FIG. 3 is a rear view of the same. The warm bath equipment includes a bed 1 and a dome 2 mounted on an upper part thereof so as to be detachable. The bed 1 includes a bed body 11, made of a stone material, that is formed in a rectangular shape slightly longer than a human's height and generates far infrared rays by heating and a frame 12 joined and integrated with a lower surface side thereof, and on the lower surface of the frame 12 and at a head side and a foot side of a bather P lying on the bed 1, transverse frames 13 are attached orthogonally with the frame 12, respectively, and a total of four supporting legs 14 that can be adjusted in height are provided on both left and right sides of the respective transverse frames 13, respectively.

Moreover, in the illustrated embodiment, large and small stone plates 31 and 32 having roughly rectangular shapes that output far infrared rays different from those output by the bed body 11 are arranged respectively at a part which the back and buttocks of the bather P lying on the upper surface of the bed body 11 contact and a part which the calves of the legs of the bather P contact. As these stone plates 31 and 32, used are, for example, ones that output more intense far infrared rays than those output by the bed body 11, by which the parts of the back, buttocks, and calves of the legs of the bather P are locally and actively warmed.

The dome 2 is made of a plurality of dome units 21 each having an arc form in section, and these units 21 are connected over the bed 1 so as to slide in the height direction of the bather P. Of the respective dome units 21, for one located at the foot side of the bather P lying on the bed 1, a side wall 21a is provided, and others are opened on both sides in the longitudinal direction, and when the bather P lies on the bed body 11, the respective dome units 21 keep inside enclosed so that steam to be described later can be filled inside. At this time, an opening part of the dome unit 21 located at the head side of the bather P is covered with a cloth 22 such as a towel so that the inside is closed off.

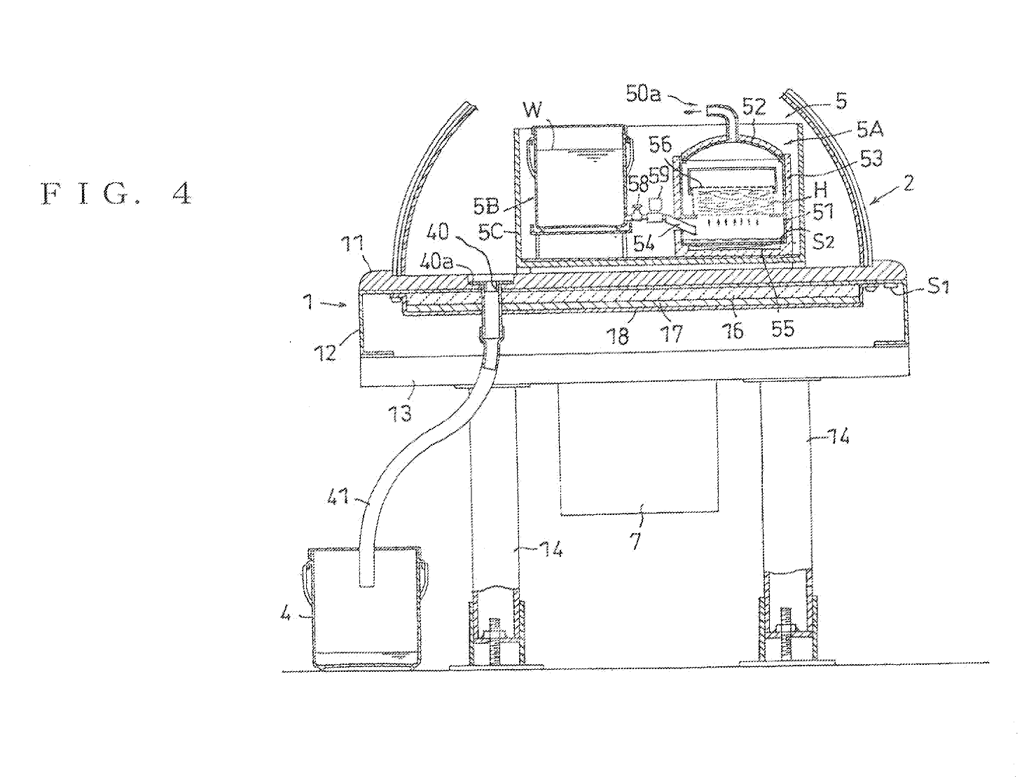

In addition, a drain tank 4 is installed at a lower part in the rear of the bed 1, and the tank 4 is connected to a drain hole 40 formed at the foot side of the bather P on the bed body 11 via a drain tube 41 to allow sweat of the bather P running down onto the bed body 11 and condensed water of steam to be described later spouted into the dome 2 to be discharged from the drain hole 40 into the tank 4 via the drain tube 41. A circular hollowed portion 40a is formed around the drain hole 40, and drainage from the drain hole 40 can be smoothly carried out via the hollowed portion 40a (see FIG. 4). At this time, by adjusting the front and rear supporting legs 14 to set the height of the bed body 11 so that the head side of the bather P becomes higher and the foot side becomes lower, drainage from the bed body 11 through the drain hole 40 and drain tube 41 into the tank 4 can be smoothly carried out.

Furthermore, a steam generator 5 is installed at an upper part in the rear of the bed 1, and perspiration of the bather P is promoted by the steam that is spouted from a nozzle 50a of the steam generator 5 and then filled in the dome 2.

FIG. 4 is an enlarged sectional view from a line X-X direction of FIG. 2. As shown in this figure, a flat heater 16 of which surface is coated with an insulator such as silicone rubber is provided on the lower surface side of the frame 12 of the bed body 11. In the illustrated embodiment, a peripheral edge portion of the frame 12 is formed in a laid U-shape in section, wherein the heater 16, a heat-insulating board 17 such as Styrofoam, and a bottom plate 18 are arranged. A temperature sensor S1 is arranged on the lower surface side of the frame 12, and temperature of the heater 16, that is, bathing temperature of the bed body 11 is controlled by the sensor S1.

Furthermore, as shown in FIG. 4, the steam generator 5 includes a steam generator body 5A and a feed-water tank 5B supplying water thereto, and both 5A and 5B are placed in a housing chamber 5C. The body 5A includes an evaporating dish 51 and a lid 52 provided at the upper part of the dish 51, and the outer circumference of these is coated with a heat insulator 53. At a side portion of the evaporating dish 51, a feed-water injection pipe 54 extending obliquely downward to supply water W from the tank 5B to the inside is provided, and a heater 55 is disposed on the rear surface of a bottom portion of the evaporating dish 51, and the water W supplied from the feed-water injection pipe 54 onto the evaporating dish 51 is heated to be evaporated by the heater 55. The vapor is discharged from the nozzle 50a into the dome.

In addition, a basket 56 containing herbs H is provided at an inner middle position of the evaporating dish 51, and by making the vapor evaporated by the heater 55 pass through the herbs H in the basket 56, herb steam is spouted from the nozzle 50a. The basket 56 is formed of a porous member such as a mesh material or a porous plate. As the herbs H contained in the basket 56, for example, mugwort, chamomile, and mint are used. These are not only excellent in promoting an effect on blood circulation and perspiration but also effective for improvement of blood circulation and treatment of gynecologic disorders. And, red rose and lavender are also used, which provide a perspiration promoting effect as well as a relaxation effect.

In addition, near the heater 55 of the evaporating dish 51, a temperature sensor S2 is arranged, and temperature of the heater 55, that is, the amount of water evaporation from the evaporating dish 51 is controlled by the sensor S2. The temperature sensor S2 of the steam generator 5A and temperature sensor S1 of the bed body 11 are connected to a control section of a control panel 7 attached to the frame 12, and the respective heaters 16 and 55 are controlled by the control section based on signals from the respective sensors S1 and S2.

In addition, a flow control valve 58 and a solenoid valve 59 are attached between the tank 5B and the feed-water injection pipe 54 having the evaporating dish 51 at a bottom portion, and the water W in the tank 5B is dropped on the feed-water injection pipe 54 from the flow control valve 58 and solenoid valve 59 to supply water onto the evaporating dish 51. Here, water may be dropped directly on the evaporating dish from the outside.

Next, procedures for using the warm bath equipment structured as above will be described. First, before bathing, the dome 2 is mounted over the bather P lying on the bed body 11 as shown in FIG. 1. At this time, the opening part of the dome unit 21 located at the head side of the bather P is covered with the cloth 22 such as a towel so that the inside of the dome can be an enclosed space. After finishing such preparations, far infrared rays generated by the bed body 11 and the large and small stone plates 31 and 32 as a result of heating by the heater 16 are irradiated onto the bather P lying on the bed body 11 in the dome 2, and simultaneously therewith, steam is spouted into the dome 2 from the nozzle 50a connected to the steam generator 5. By an effect of the far infrared rays and steam, perspiration is sufficiently promoted so that a health enhancement effect on the bather P can be obtained. In addition, as shown in FIG. 4, by spouting herb steam from the nozzle 50a of the steam generator 5, perspiration of the bather P is further promoted, and moreover, a healing effect can be obtained.

When giving a massage to the bather P after bathing, the dome 2 is removed from the bed body 11 with the respective units 21 folded and is housed in a space below the bed body 11 as shown in FIG. 1.

According to the warm bath equipment of the present invention, sufficient perspiration can be effectively provided on the bather to contribute to beauty and health enhancement.

What is claimed is:

1. A warm bath equipment comprising:
a bed body made of a stone plate for generating far infrared rays; and
a dome mounted on the bed body so as to be detachable, wherein
a nozzle connected to a steam generator is arranged at one side in a longitudinal direction on an upper surface of the bed body.

2. The warm bath equipment according to claim 1, wherein a waterproof heater for heating the bed body is provided.

3. The warm bath equipment according to claim 1 or 2, wherein herb steam is spouted from the nozzle of the steam generator.
